(19) United States
(12) Patent Application Publication
(10) Pub. No.: US 2022/0042500 A1
(43) Pub. Date: Feb. 10, 2022

(54) HIGH-VISCOSITY FLUID DOSE ISOLATORS

(71) Applicant: Hewlett-Packard Development Company, L.P., Spring, TX (US)

(72) Inventors: Yinon Harari, Ness Ziona (IL); Alexander Yekymov, Ness Ziona (IL); Ziv Seemann, Ness Ziona (IL)

(73) Assignee: Hewlett-Packard Development Company, L.P., Spring, TX (US)

(21) Appl. No.: 17/297,701

(22) PCT Filed: Dec. 17, 2018
(86) PCT No.: PCT/US2018/065985

§ 371 Date: May 27, 2021

(51) Int. Cl. F04B 13/00; F04B 15/02; F04B 49/06; F04B 49/08

(52) U.S. Cl. CPC F04B 13/00; F04B 15/02; B41J 2/17596; F04B 49/08; F04B 49/065

(57) ABSTRACT

In one example, a fluid delivery system (10) comprises a pump cavity (1) to receive a high-viscosity fluid, such that when full, the pump cavity (1) is to define a dose of high-viscosity fluid. The system (10) further comprises an access (2) to the pump cavity (1), to provide fluid communication with the pump cavity (1), and a plunger (3) to block the access (2) to the pump cavity (1) and isolate the dose of the high-viscosity fluid for ejection of the dose by the plunger (3).

### BACKGROUND

Certain processes utilize high-viscosity fluids. For example, some commercial and industrial printing systems use printing fluids that are extremely viscous. In some examples, such high-viscosity printing fluids are provided in a receptacle, such as a printing fluid tube. The high-viscosity fluid is extracted from the printing fluid tube and provided to a print head of a printing system. High-quality printing is output when accurate extraction and dosing of the high-viscosity printing fluid is achieved.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic view of a high-viscosity fluid delivery system in accordance with an example;

FIG. 2a is a schematic view of a high-viscosity fluid delivery system in a first position accordance with another example;

FIG. 2b is a schematic view of the high-viscosity fluid delivery system of FIG. 2a in a second position;

FIG. 3 is a schematic view of a high-viscosity fluid delivery system in accordance with another example;

FIG. 4 is a flow diagram showing a method in accordance with an example; and

FIG. 5 is a schematic diagram showing an example set of computer readable instructions within a non-transitory computer-readable storage medium.

### DETAILED DESCRIPTION

In the following description, for purposes of explanation, numerous specific details of certain examples are set forth. Reference in the specification to “an example” or similar language means that a particular feature, structure, or characteristic described in connection with the example is included in that one example, but not necessarily in other examples.

In commercial and industrial printing systems, high-viscosity printing fluid is often provided in a receptacle, such as a printing fluid tube. The printing fluid tube is a cartridge comprising a housing, a moveable member and an outlet. When the moveable member is moved relative to the housing, high-viscosity printing fluid provided on one side of the moveable member is forced out of the housing through the outlet.

The nature of high-viscosity fluids means a large amount of energy is needed to displace the fluid. High-viscosity fluids, such as high-viscosity printing fluids, can contain a large percentage of trapped air. The air can affect the throughput of the high-viscosity printing fluid.

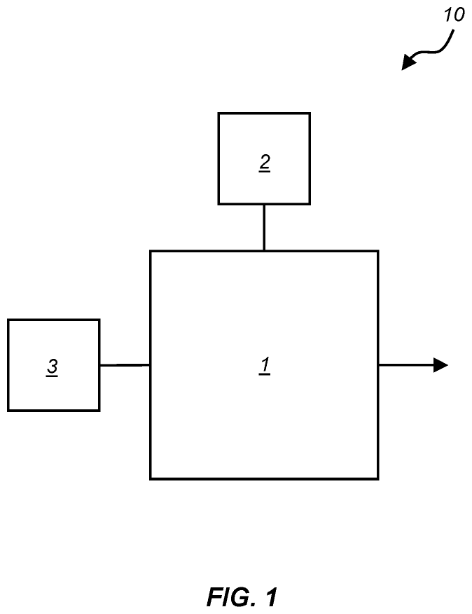

FIG. 1 schematically illustrates a high-viscosity fluid delivery system 10. The system 10 is suitable to deliver high-viscosity printing fluid.

According to the example of FIG. 1, the system 10 comprises a pump cavity 1 to receive a high-viscosity fluid, such that when full, the pump cavity 1 is to define a dose of high-viscosity fluid. The system 10 also comprises an access 2 to the pump cavity 1, to provide fluid communication with the pump cavity 1. The system 10 further comprises a plunger 3 to block the access 2 to the pump cavity 1 and isolate the dose of the high-viscosity fluid for ejection of the dose by the plunger 3.

The access 2 is to allow for a change of a volume of the high-viscosity fluid in the pump cavity 1. In some examples, the access 2 is an opening which, when unblocked, allows free movement of the high-viscosity fluid into and out of the pump cavity 1. That is, the access 2 is to provide multidirectional flow of the high-viscosity fluid through the access 2.

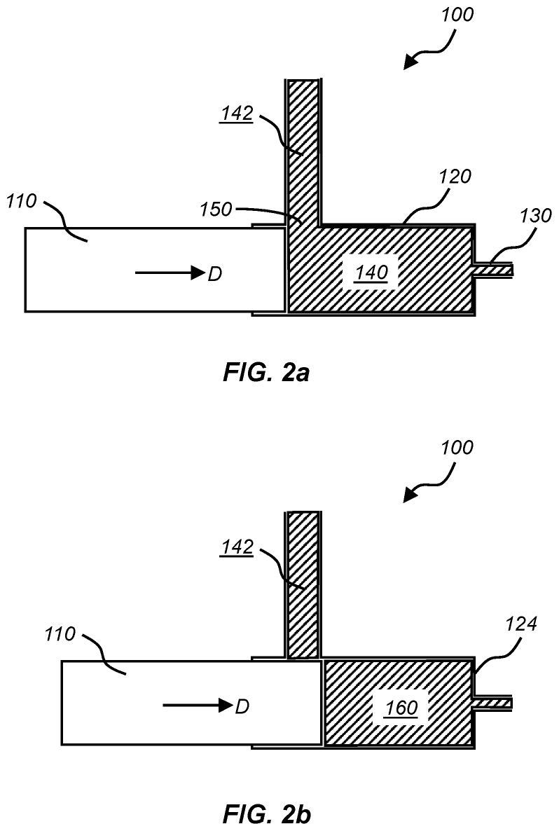

FIG. 2a schematically illustrates a high-viscosity fluid delivery system 200 in a first position according to an example.

The system 200 comprises a plunger 110 moveable within a chamber 140 along an advancing direction D to eject high-viscosity fluid through an outlet 130. The plunger 110 is therefore a driving member to impart force on the high-viscosity fluid. In some examples, an advance of the plunger 110 causes the plunger 110 to slide in the chamber 140. In some instances, the plunger 110 is referred to as a pressurizer because the plunger 110 pressurizes the high-viscosity fluid. The outlet 130 is to comprise a valve that is to open and close, such that high-viscosity fluid is to be expelled from the chamber 140 when the outlet 120 is open but not when the outlet 120 is closed. An example of a suitable valve is a one-way check valve that allows fluid to flow through the valve in one-direction but prevents flow in all other directions.

In the example shown, the system 100 comprises a wall 120 which defines the chamber 140. The wall 120 forms part of a perimeter of the chamber 140. The plunger 110 is to advance in the chamber 140 by sliding movement within and/or along the wall 120. The dimensions of the plunger 110 and wall 120 are therefore complimentary to ensure the plunger 110 is moveable with the chamber 140 but is not severely restricted by the wall 120. The tolerance in fitting between the chamber 140 and the wall 120 is to provide a seal between the chamber 140 and the wall 120 that is formed between the high-viscosity fluid and the surrounding surfaces.

The high-viscosity fluid is to enter the chamber 140 through a passageway 142. The passageway 142 is fluidly connected to the chamber 140 when an access 150 is unblocked. When the access 150 is blocked, the passageway 142 and chamber 140 are substantially fluidly disconnected to isolate a dose of high-viscosity fluid in a pump cavity 160 which is formed from the chamber 140. In some examples, an additional driving member (not shown), which is distinct from the plunger 110, is used to force the high-viscosity fluid through the passageway 142 and into the chamber 140. In some instances, the additional driving member is to be in fluid communication with the plunger 110, for example when the fluid is first entering the chamber 140 and when the fluid in the chamber 140 is being pressurized by the additional driving member.

In some examples, fluid communication is established between the additional driving member and the plunger 110 due to the absence of a fluid gate, such as a check-valve, that is to significantly reduce or prevent fluid flow. In other systems, the fluid communication may be achieved by opening all fluid gates, such as check-valves, for example one-way check-valves, present between the additional driving member, the plunger 110 and the outlet 130 that could impede fluid flow in the chamber 140. This enables the additional driving member to maintain a “charge” of fluid pressure in the chamber 140 before the second driving member 140 is to provide a driving force to expel fluid through the outlet 130.

As mentioned, the system 100 shown comprises an access 150. The access 150 is an opening that provides for fluid communication with the chamber 140 and the pump cavity 160 of the chamber 140 (see FIG. 2b), which is defined as an isolation of the high-viscosity fluid when the plunger 110 blocks the access 150.

The access 150 separates the passageway 142 and the chamber 140 by interposing the passageway 142 and the chamber 140. When the access 150 is unblocked, high-viscosity fluid can freely flow through the access 150 and between the passageway 142 and the chamber 140. This allows the chamber 140 to fill with high viscosity fluid. When the high-viscosity fluid is pressurized, the system 100 is to move high-viscosity fluid along a fluid path. The fluid path comprises a supply side and an output side. In some examples, the plunger 110 is downstream of the additional driving member (not shown in FIGS. 2a and 2b). That is, the plunger 110 is positioned in the system 100 closer to the outlet 130 along the fluid path than the additional driving member.

In some examples, the additional driving member comprises a moveable member within a printing fluid tube. The moveable member is to change a volume of high-viscosity fluid in a reservoir which comprises the passageway 142 and the chamber 140 to impart force on the high-viscosity fluid within the reservoir. When working with compressible fluids, such as high-viscosity fluids that contain air bubbles, the high-viscosity fluid is compressed by action of the moveable member due to the presence of air. The moveable member may therefore advance to increase a pressure of the high-viscosity fluid or withdraw to decrease a pressure of the high-viscosity fluid.

In FIG. 2a, the system 100 is shown in a first position. The first position comprises an access 150 which is unblocked. Thus, high-viscosity fluid can move into and from the chamber 140. Also, it is possible to impart force on the high-viscosity fluid in the chamber 140 by transmitting force through high-viscosity fluid in the passageway 142, for example, by the additional driving member (not shown). Advancing the plunger 110 in the advancing direction D, causes the access 150 to progressively restrict. Once the plunger 110 is advanced past the access 150, the plunger 110 blocks the access 150, as shown in FIG. 2b.

FIG. 2b shows a second position of the system 100, whereby the access 150 is blocked by the plunger 110 as the plunger 110 moves relative to an end stop 124. In the second position, the pump cavity 160, which was part of the chamber 140, is isolated by the plunger 110. Since the chamber 160 was full of high-viscosity fluid, the pump cavity 160 is full of high-viscosity fluid. In the second position, high-viscosity fluid between the passageway 142 and the pump cavity 160 can no longer flow freely between each other due to the tolerances between the plunger 110 and the wall 120 of the chamber 140 and pump cavity 160.

In the second position shown in FIG. 2b, a dose of high-viscosity fluid is prepared by isolating the high-viscosity fluid using the plunger 110 to block the access 150. Continuing to advance the plunger 110 towards the end stop 124 causes ejection of the dose of high-viscosity fluid from the pump cavity 160. In some examples, the ejection process corresponds to a full stroke of the plunger 110 in the pump cavity 160.

Withdrawing the plunger 110 from the end of a stroke, for example from the end stop 124, in a direction opposite to the advancing direction D, allows the access 150 to become unblocked again. Given that the additional driving member maintains pressure on the high-viscosity fluid away from the pump cavity 160 and chamber 140, the high-viscosity fluid is forced back into the pump cavity 160. The withdrawing also causes a reduced pressure, for example a vacuum, which assists the filling of the pump cavity 160. As high-viscosity fluid enters the pump cavity 160 for a second stroke of the plunger 110, the pressure in the passageway 142 decreases. As long as the pressure in the passageway 142 does not decrease below a predetermined amount, the plunger 110 may continue to eject a dose of high-viscosity fluid. However, when the pressure in the passageway 142 decreases below the predetermined amount, the additional driving member may move to increase the pressure of the high-viscosity fluid to an acceptable level and above the predetermined amount. This provides for multiple strokes of the plunger 110 within a working window of pressure of the supply side of the high-viscosity fluid.

The system 100 provides a dosage that is carefully controlled and easy to interpret. A volume of each dosage is repeatable and interpretable without measurement of the actual flow rate of the dosage. An accurate output dosage is ensured and controlled with each ejection. The volume of high-viscosity fluid ejected is determined based on the knowledge that the pump cavity 140 is always full. A full pump cavity 140 is interpreted based on a pressure away from the pump cavity 140. This provides for efficient operation and indirect interpretation of a dosage.

By using a plunger 110 to block off the access 150 and prevent fluid communication between the passageway 142 and the pump cavity 160, the plunger 110 can operate at significantly higher pressures than the pressure used to fill the chamber 140 and the pump cavity 160. A filling of the chamber 140 and the pump cavity 160 is at a low pressure to prevent damage to a supply side container, such as a printing fluid tube (not shown). In contrast, the pressure to eject high-viscosity fluid from the pump cavity 160 is at a relatively high pressure. In some examples, the pressure of the high-viscosity fluid by action of the plunger 110 when the access 150 is blocked is of the order of 50 to 100 times greater than the pressure of the high-viscosity fluid by action of the additional driving member when the access 150 is unblocked. Although in most instances, a printing fluid tube can elastically deform to a degree, the printing fluid tube will be permanently damaged if the pressures are too high, such as the pressures that occur in the pump cavity 160 by the plunger 110. Therefore, closing off the access 150 by the plunger 110 is prevents permanent damage to a printing fluid tube. In some examples, a maximum pressure of the high-viscosity fluid in the pump cavity 160, when the access 150 is unblocked, is 2 bar. In contrast, a maximum pressure of the high-viscosity fluid in the pump cavity 160, when the access is blocked, is at least 100 bar to 200 bar.

Blocking the access 150 using the plunger 110 reduces the number of component parts in the system 100. This helps to reduce the complexity of the system 100. Further, the use of a one-way check valve is not needed which improves fluid flow. The absence of a check valve reduces maintenance concerns and operation monitoring needs.

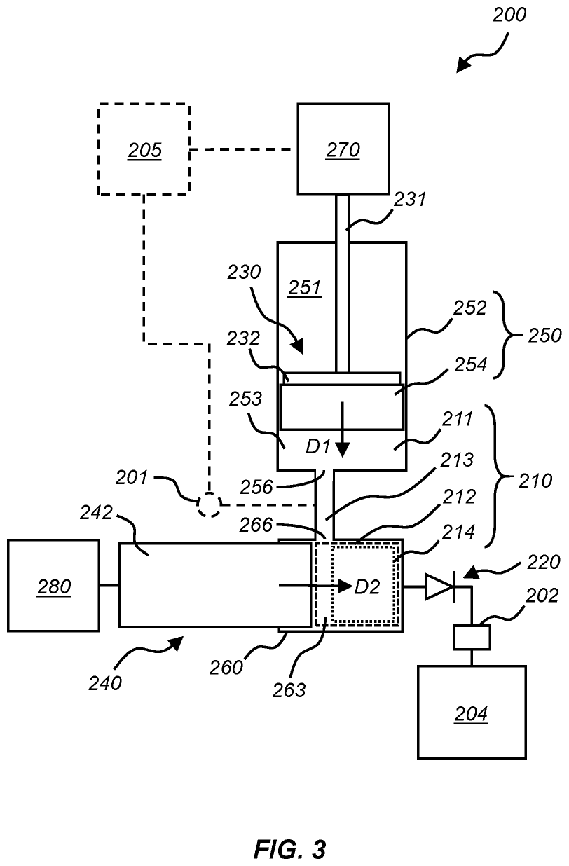

FIG. 3 schematically illustrates a high-viscosity fluid delivery system 200 according to an example. The fluid delivery system 200 comprises a reservoir 210 communicable with an outlet 220, a first driving member 230 and a second driving member 240. The first and second driving members 230, 240 are to impart force on the reservoir 210. In most instances, the imparting of the force by the first and second driving members 230, 240 is not simultaneous, at least when an inlet to a pump cavity 214 is blocked. The first driving member 230 is to impart a force resulting in a low-pressure fluid, whereas the second driving member 240 is to impart a force resulting in a high-pressure fluid. When the inlet 266, which is an access, is unblocked and high-viscosity fluid is contained in the reservoir 210, a pressure of the high-viscosity fluid in the reservoir 210 is changed by the first driving member 230. Examples of suitable high-viscosity fluids include high-viscosity printing fluids.

High-viscosity fluid is initially stored in a fluid vessel 250 and brought to the system 200 to form the reservoir 210. In some examples, the fluid vessel 250 is a printing fluid tube, which is a cartridge to store high-viscosity printing fluid. The fluid vessel 250 comprises a housing 252 and a moveable member 254. The moveable member 254 is moveable relative to the housing 252. In the example shown, the moveable member 254 reciprocates relative to the housing 252. The fluid vessel 250 comprises a first volume 251, a second volume 253 and a moveable member 254. The moveable member 254 separates the first and second volumes 251, 253. The moveable member 254 is to change a size of the first and second volumes 251, 253 by relative movement of the moveable member 254 to the housing. When the fluid vessel 250 is full, the second volume 253 is at a maximum size and the first volume 251 is at a minimum size. The first volume 251 is to increase in size as high-viscosity fluid is expelled from the fluid vessel 250, whereas the second volume 253 is to decrease in size. In the example shown, the first and second volumes 251, 253 are closed, except for an outlet 256 in the fluid vessel 250 that is to communicate with the second volume 253.

The first driving member 230 comprises a rod 231, a piston 232, and a moveable member 254, wherein the moveable member 254 is driven by the rod 231 and piston 232. The piston 232 is connected to the rod 231 and imparts forces on the moveable member 254. An energy source 270 provides the motive force to drive the first driving member 230 and move the first driving member 230. In some examples, the energy source 270 is a pneumatic energy source. That is, the first driving member 230 may be pneumatically driven.

The second driving member 240 of the system 200 is downstream of the first driving member 230. The second driving member 240 is a moveable member 242. In some examples, the moveable member 242 is a plunger of a plunger pump. The moveable member 242 is to move relative to the pump cavity 214. In some examples, a sealing member is coupled to a housing 260 and is to prevent fluid release from the housing 260. The plunger pump is therefore to comprise the sealing member, the moveable member 242 and the housing 260. The housing 260 defines a fourth volume 263 to receive fluid from the second volume 253 of the fluid vessel 250. Fluid is to enter the fourth volume 263 through the inlet 266, which is an access.

High-viscosity fluid from the fluid vessel 250 fills the reservoir 210 as the high-viscosity fluid is expelled from the fluid vessel 250. Expulsion of high-viscosity fluid from the second volume 253 occurs by advancing the first driving member 230 in a first advancing direction D1 in the housing 260. Pressure of the reservoir 210 is to increase when the reservoir 210 is full of high-viscosity fluid. Although air bubbles are likely to be present in the reservoir 210, the reservoir 210 can be considered full when a boundary of the reservoir 210 is entirely wetted by the fluid and movement of the fluid, in all directions, is prevented. In some instances, the reservoir 210 is considered full when a fluid pressure is attained. The boundary of the reservoir 210 comprises the first and second driving members 230, 240. Therefore, movement of the first and second driving members 230, 240 affects the boundary of the reservoir 210 and changes a size of the reservoir 210.

The reservoir 210 comprises a first chamber 211 and a second chamber 212, which includes the pump cavity 214. The second chamber 212 is schematically shown using dashed lines, whereas the pump cavity 214, which defines a volume of a dose for ejection, is schematically shown using dotted lines. In some examples, the second chamber 212 is greater in size than the pump cavity 214 in a first dimension. In the example shown, the first dimension is a longitudinal direction, which is also the same direction as the advancing direction D2. The first dimension may be the one dimension by which the second chamber 212 is greater than the pump cavity 214. In some examples, the second chamber 212 is a cylinder and the pump cavity 214 is a portion of the cylinder. Although the pump cavity 214 of FIG. 3 is shown to be smaller in all directions than the second chamber 212, this is for illustration purposes.

In the example shown, a third, intermediate chamber 213 or passageway is shown interposed between the first and second chambers 211, 212 to enable transportation of the high-viscosity fluid between the first and second chambers 211, 212. In some examples, the third, intermediate chamber 213 is an inlet manifold of the second chamber 212. In other examples, the third, intermediate chamber 213 may not be present, for example, the reservoir 210 may comprise the first chamber 211 directly coupled to the second chamber 212 without the third, intermediate chamber 213. In this instance, the first chamber 211 is the passageway that is fluidly connected to the pump cavity 214 by the inlet 266 when the inlet 266 is unblocked by the moveable member 242.

A pressure of the reservoir 210 is to increase by action of the first driving member 230 to “charge” the reservoir 210. During action of the first driving member 230, the outlet 220 of the reservoir 210 is closed to contain high-viscosity fluid in the reservoir 210. The action includes advancing the first driving member 230 in advancing direction D1 to reduce a size of the reservoir 210. While the first driving member 230 is advanced, the second driving member 240 is held in position. The first driving member 230 ensures the reservoir 210, particularly the second chamber 212, is sufficiently filled with high-viscosity fluid to ensure adequate extraction of high-viscosity fluid from the system 200 by metering a dose high-viscosity fluid as defined by the pump cavity 214.

In some examples, the pressure of the reservoir 210 or at least a portion of the reservoir 210 is monitored. For example, a pressure sensor 201 can be used to measure a pressure of the reservoir 210 and detect a change in pressure of high-viscosity fluid in the reservoir 210. The pressure sensor 201 is located upstream of the second driving member 240 and outlet 220. A signal from the pressure sensor 201 is received by a controller 205. The controller 205 detects a pressure of the reservoir 210, by the pressure sensor 201, and determines whether the pressure is within a working range, sometimes referred to as a working window. If the pressure is too low, the controller 205 causes the first driving member 230 to advance by activation of the energy source 270. The change in pressure is a positive change in pressure in that the pressure of the fluid in the reservoir 210 increases. A working range may be of the order of 1 bar of pressure. A lower limit of the working range may be between 0 bar and 0.1 bar. An upper limit of the range may be between 0.9 bar and 1.1 bar.

The energy source 270 causes the first driving member 230 to impart a force on the reservoir 210. Force is to be imparted when the rod 231 and piston 232 transmit force to the moveable member 254. Some fluid in the pump cavity 214 may flow back past the moveable member 242 between the housing 260 and the moveable member 242 and towards the inlet 266. Since the fluid is a high-viscosity fluid, the flow back, or “back flow”, of high-viscosity fluid results in the creation of a fluid seal between the housing 260 and the moveable member 242. Although some high-viscosity fluid may be forced away from the pump cavity 214, some high-viscosity fluid will act as a sealant to prevent further “back flow” of fluid from the pump cavity or significantly reduce “back flow”. Therefore, an effective seal is achieved by the high-viscosity fluid with the surrounding surfaces.

When the controller 205 detects the pressure of the high-viscosity fluid in the reservoir 210 is within a working range, the first driving member 230 does not advance. In most instances, the first driving member 230 is therefore maintained in position to hold the pressure of the high-viscosity fluid in the reservoir 210 within the working range. Holding a position of the first driving member 230 keeps the pressure of the reservoir 210 stable until the volume of dose ejected by the second driving member 240 leads to the pressure of the high-viscosity fluid in the reservoir 210 to be outside of the working range. Within the working range, the first driving member 230 resists the pressure exerted in return by the high-viscosity fluid. That is, the pressure exerted by the high-viscosity fluid as defined by the combination of the first chamber 211 and the third, intermediate chamber 213 when the inlet 266 is blocked by the moveable member 242. In some examples, this is achieved by locking a position of the first driving member 230. In this example, the position is effectively locked by the energy source 270 which imparts force on the first driving member 230 and moveable member 254.

The second driving member 240 is used to determine a dose of high-viscosity fluid to be ejected from the system 200 and to isolate the high-viscosity fluid to forming the dose. The second driving member 240 is also activated to drive the dose of high-viscosity fluid from the reservoir 210. By providing a full pump cavity 214, the metering of a dose of high-viscosity fluid is accurate and repeatable.

The system 200 is shown with an energy source 280 to provide the motive power to impart force to and drive the second driving member 240 and advance the second driving member 240. In some examples, the energy source 280 is a pneumatic energy source. That is, the second driving member 240 may be pneumatically driven. When the controller 205 determines the reservoir 210 is pressurized to within the working range, the second driving member 240 is advanced, in an advancing direction D2. The advancement of the second driving member 240 is to block the inlet 266 to isolate a dose of the high-viscosity fluid in the pump cavity 214, for ejection of the dose by the second driving member 240. At this point the outlet 220, which comprises a one-way check valve, is closed because the advancement of the second driving member 240 causes the pressure in the pump cavity 214 to increase to open the outlet 220. When the outlet 220 is open, the dose of high-viscosity fluid is driven out of the pump cavity 214. When the outlet 220 is open and the dose is ejected from the outlet 220, the dose is sent to a nozzle 202 for dispersing the dose.

In some examples, the one-way valve, that forms part of the outlet 220, allows movement through the outlet 220 in one direction. The one-way valve prevents a back flow of high-viscosity fluid to the pump cavity 214 because the one-way valve ensures that high-viscosity fluid exits the pump cavity 214 in one direction.

The nozzle 202, which forms part of the system 200, is positioned downstream of the outlet 220. In some examples, the nozzle 202 operates under fluid pressure such that high-viscosity fluid is dispersed from the nozzle 202 as the high-viscosity fluid is forced through the nozzle 202. That is, the nozzle 202 acts as a second outlet downstream of a first outlet (outlet 220), wherein the outlet 220 is to provide fluid communication between the pump cavity 214 and the nozzle 202. The system 200 further comprises a tank 204 to receive high-viscosity fluid from the reservoir 210. High-viscosity fluid in the tank 204 may be combined with other substances to provide a combined fluid for use in a device. In some examples, the device is a printer, and the combined fluid is printing fluid for use in a print head of the printer.

The system 200 is to output a predetermined dose of high-viscosity fluid from the pump cavity 214 by movement of the moveable member 242 in the advancing direction D2. A single dose of high-viscosity fluid is therefore ejected from the pump cavity 214, regardless of the starting position or speed of the moveable member 242. The second driving member 240 which is the moveable member 242 is a quantifier that determines a dosage of fluid is repeatedly ejected. When the second chamber 212 is ensured full of high-viscosity fluid, the pump cavity 214 comprises substantially the same dose, or an acceptably similar dose, of high-viscosity fluid for ejection by the moveable member 242. In some examples, the acceptably similar dose is defined within a predetermined window set by the working range of high-viscosity fluid pressure by the first driving member 230. By monitoring and maintaining a pressure of the reservoir 210 in a working range by a determiner (comprising the controller 205 and the pressure sensor 201), the pump cavity 214 is ensured to be full and a predictable dose is ejected.

Movement of the moveable member 242 is used to provide a measured dose of high-viscosity fluid without having to measure the flow rate of the high-viscosity fluid. Therefore, instead of measuring the flow rate, the system 200 ensures the second chamber 212 is full and at a pressure within a working range. Although the moveable member 242 may be equipped with a position sensor to collect and relay position data identifying the position of the moveable member 242 or a measure of advance of the moveable member 242, determining a full stroke has occurred is needed. In some examples, a position sensor may not be used and a time of activation of the moveable member 242 may be all that is needed to ascertain the degree of movement of the moveable member 242 to interpret a full stroke has occurred. In some systems, a partial stroke may be used by the dose will be different than a full stroke for the same system with the same pressure and characteristics of high-viscosity fluid.

The system 200 operates as a “closed-loop”, whereby the volume of fluid expelled through the outlet 220 is not monitored but is interpreted by the behavior of the system 200. That is, an output dose of high-viscosity fluid from the pump cavity 214 is determined using information about the pumping action, wherein the pumping action is caused by the second driving member 240.

If the pressure sensor 201 detects a decrease of pressure of the high-viscosity fluid in the reservoir 210 below the working range, the first driving member 230 is to engage and to “re-charge” the reservoir 210 to force fluid in the first chamber 211 towards the second chamber 212. The controller 205 activates the energy source 270 and the moveable member 254 of the first driving member 230 is advanced in the advancing direction D1. During the re-charging of the reservoir 210, the second driving member 240 is to be held in position or is withdrawn in a direction opposite to the advancing direction D2 of the second driving member 240, that is a withdrawing direction. Once the reservoir 210 is “re-charged” again and the pressure of the reservoir 210 restored, such that the pressure of the reservoir 210 is within the working range, the second driving member 240 is to expel fluid from the reservoir 210 once more.

The system 200 determines information of a characteristic of the high-viscosity fluid, such as a current pressure, away from the pump cavity 212. The range of pressures away from the pump cavity 212 are much lower than the range of pressures in the pump cavity 212 because the second driving member 240 operates at much higher pressures than the first driving member 230. The lower pressure of the first driving member 230 are to avoid damage to the housing 252 of the fluid vessel 250, which may be a housing of a printing fluid tube.

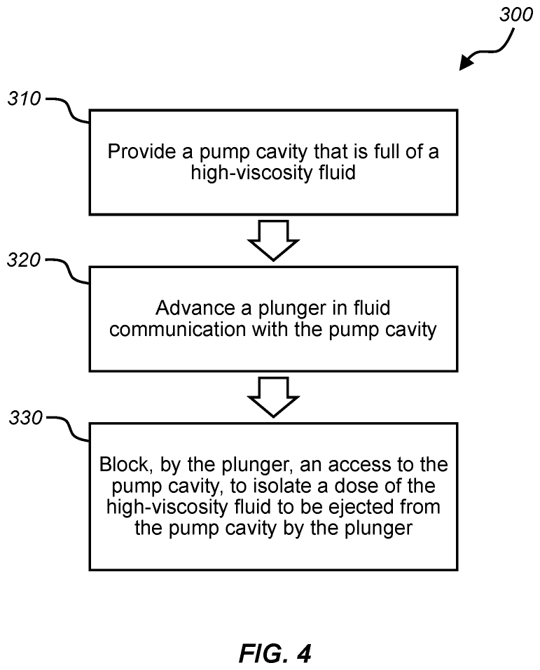

FIG. 4 illustrates a flow diagram of a method 300. The method 300 can be performed by any one of the fluid delivery systems 10, 100, 200 discussed in relation to FIGS. 1 to 3. At block 310, the method 300 comprises providing a pump cavity that is full of a high-viscosity fluid. At block 320, the method 300 comprises advancing a plunger in fluid communication with the pump cavity. At block 330, the method 300 comprises blocking, by the plunger, an access to the pump cavity, to isolate a dose of the high-viscosity fluid to be ejected from the pump cavity by the plunger. The access is not part of the plunger and is arranged away from the plunger.

In some examples, block 320 comprises advancing the plunger with respect to the access to progressively restrict the access by movement of the plunger across the access. In some examples, block 320 comprises advancing comprises advancing the plunger in a chamber comprising the pump cavity and the access.

In some examples, block 310 comprises determining the pump cavity is full of the high-viscosity fluid according to information of a characteristic of the high-viscosity fluid. In some examples, the characteristic of the high-viscosity fluid is a pressure of the high-viscosity fluid and the information is a current pressure of the high-viscosity fluid away from the pump cavity.

In some examples, block 310 may comprise increasing a pressure of the high-viscosity fluid in the pump cavity by exerting force, by a driving member, on a passageway that is fluidly connected to the pump cavity by the access. A pressurizer, corresponding to the first driving member, as described in relation to the example of FIG. 3, may be used to increase the pressure of the high-viscosity fluid, for example. The ejection of the high-viscosity fluid by the plunger may be cause by the opening of a one-way check valve that opens when a predetermined pressure is reached. The second driving member, as described in relation to the example of FIG. 1, is an example of the plunger.

In some examples, block 320 may comprise detecting a pressure of the reservoir outside of the working range and causing activation of the pressurizer to restore the pressure within the working range.

In some examples, block 310 comprises filling the pump cavity under pressure, by the force exerted on the high-viscosity fluid outside of the pump cavity by a pressurizer, as the access is unblocked by the plunger withdrawing with respect to the access.

The method 300 may comprise an additional block of activating a pressurizer to restore the pressure of the high-viscosity fluid within a working range on the basis of determining a partially full pump cavity by detecting the current pressure is outside of the working range. In some examples, the pressurizer corresponds to the first driving member, as described in relation to the example of FIG. 3.

In some examples, the block 330 comprises sliding the plunger within the pump cavity and across the access to prevent a back flow of the high-viscosity fluid in the pump cavity through the access.

Certain system components and methods described herein may be implemented by way of non-transitory computer program code that is storable on a non-transitory storage medium. In some examples, the controller 260 may comprise a non-transitory computer readable storage medium comprising a set of computer-readable instructions stored thereon. The controller 260 may comprise at least one processor. Alternatively, at least one controller 260 may implement all or at least one part of the methods described herein.

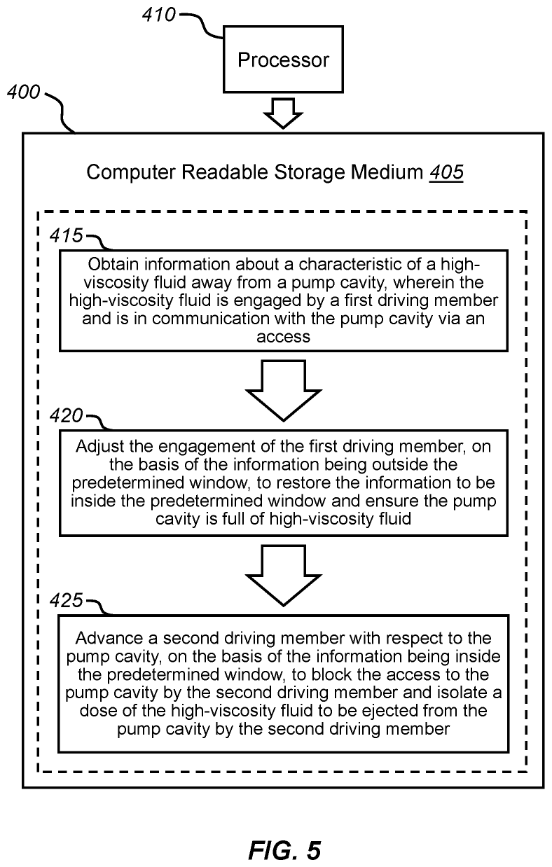

FIG. 5 shows an example of such a non-transitory computer readable storage medium 405 comprising a set of computer readable instructions 400 which, when executed by at least one processor 410, cause the at least one processor 410 to perform a method according to examples described herein. The computer readable instructions 400 may be retrieved from a machine-readable media, e.g. any media that can contain, store, or maintain programs and data for use by or in connection with an instruction execution system. In this case, machine-readable media can comprise any one of many physical media such as, for example, electronic, magnetic, optical, electromagnetic, or semiconductor media. More specific examples of suitable machine-readable media include, but are not limited to, a hard drive, a random access memory (RAM), a read-only memory (ROM), an erasable programmable read-only memory, or a portable disc.

In an example, instructions 400 cause the processor 410 in a fluid delivery system to, at block 415, obtain information about a characteristic of a high-viscosity fluid away from a pump cavity, wherein the high-viscosity fluid is engaged by a first driving member and is in communication with the pump cavity via an access. In some examples, the characteristics is a pressure and the information is a current pressure of the high-viscosity fluid in the pump cavity. In some examples, a block may include interpreting the current pressure of the pump cavity by measuring the current pressure of the high-viscosity fluid away from the pump cavity.

At block 420, the instructions 400, cause the processor 410 to, adjust the engagement of the first driving member, on the basis of the information being outside the predetermined window, to restore the information to be inside the predetermined window and ensure the pump cavity is full of high-viscosity fluid.

At block 425, the instructions 400, cause the processor 410 to, advance a second driving member with respect to the pump cavity, on the basis of the information being inside the predetermined window, to block the access to the pump cavity by the second driving member and isolate a dose of the high-viscosity fluid to be ejected from the pump cavity by the second driving member.

In another example, the set of instructions 400 may comprise activating a supply side of the pump cavity to allow adjustment of the first driving member and cause a change in value of the information, such that, when the information reaches a predetermined level, the second driving member is to be advanced to cause the high-viscosity fluid in the pump cavity to be released from the pump cavity. The predetermined level may be a pressure of the high-viscosity fluid that corresponds to a lower limit of the predetermined window. The predetermined window may be a pressure range, such that the and the predetermined level is a minimum working pressure. The engaging of the supply side may occur before an upper limit of the predetermined window is exceeded, such as a maximum working pressure.

In another example, the set of instructions may comprise a further block comprising causing the processor to, on the basis of the information, engage the supply side of the pump cavity to maintain a value of the information when the access is unblocked. In further examples, the instructions may comprise, causing an increase of pressure of the high-viscosity fluid on the supply side after a plurality of strokes of the second driving member to respectively eject a plurality of doses of the high-viscosity fluid from the pump cavity to “re-charge” the supply side to a pressure that is within a predetermined window.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method comprising:
providing a pump cavity that is full of a high-viscosity fluid;
advancing a plunger in fluid communication with the pump cavity; and
blocking, by the plunger, an access to the pump cavity, to isolate a dose of the high-viscosity fluid to be ejected from the pump cavity by the plunger.

2. The method of claim 1, wherein the advancing comprises advancing the plunger with respect to the access to progressively restrict the access by movement of the plunger across the access.

3. The method of claim 1, wherein the advancing comprises advancing the plunger in a chamber comprising the pump cavity and the access.

4. The method of claim 1, wherein the providing comprises determining the pump cavity is full of the high-viscosity fluid according to information of a characteristic of the high-viscosity fluid.

5. The method of claim 4, wherein the characteristic of the high-viscosity fluid is a pressure of the high-viscosity fluid and the information is a current pressure of the high-viscosity fluid away from the pump cavity.

6. The method of claim 1, wherein the providing comprises increasing a pressure of the high-viscosity fluid in the pump cavity by exerting force, by a driving member, on a passageway that is fluidly connected to the pump cavity by the access.

7. The method of claim 6, wherein the providing comprises filling the pump cavity under pressure, by the force exerted on the high-viscosity fluid outside of the pump cavity by a pressurizer, as the access is unblocked by the plunger withdrawing with respect to the access.

8. The method of claim 5, comprising activating a pressurizer to restore the pressure of the high-viscosity fluid within a working range on the basis of determining a partially full pump cavity by detecting the current pressure is outside of the working range.

9. The method of claim 3, wherein the blocking comprises sliding the plunger within the pump cavity and across the access to prevent a back flow of the high-viscosity fluid in the pump cavity through the access.

10. A system comprising:
a pump cavity to receive a high-viscosity fluid, such that when full, the pump cavity is to define a dose of high-viscosity fluid;
an access to the pump cavity, to provide fluid communication with the pump cavity; and
a plunger to block the access to the pump cavity and isolate the dose of the high-viscosity fluid for ejection of the dose by the plunger.

11. The system of claim 10 comprising:
a determiner to determine the pump cavity is full of the high-viscosity fluid based on information of a characteristic of the high-viscosity fluid.

12. The system of claim 11, wherein the determiner comprises:
a pressure sensor to measure a current pressure of the high-viscosity fluid away from the pump cavity; and
a controller to detect the current pressure is within a working range.

13. The system of claim 12, wherein the pressure sensor is to detect a current pressure of high-viscosity fluid in a passageway that is fluidly connected to the pump cavity by the access.

14. The system of claim 10, comprising a pressurizer to exert a force on the high-viscosity fluid outside of the pump cavity and to pressurize the pump cavity when the access is unblocked by the plunger.

15. A non-transitory computer readable storage medium comprising a set of computer-readable instructions stored thereon, which, when executed by a processor, cause the processor to, in a high-viscosity fluid delivery system:
obtain information about a characteristic of a high-viscosity fluid away from a pump cavity, wherein the high-viscosity fluid is engaged by a first driving member and is in communication with the pump cavity via an access;
adjust the engagement of the first driving member, on the basis of the information being outside the predetermined window, to restore the information to be inside the predetermined window and ensure the pump cavity is full of high-viscosity fluid; and
advance a second driving member with respect to the pump cavity, on the basis of the information being inside the predetermined window, to block the access to the pump cavity by the second driving member and isolate a dose of the high-viscosity fluid to be ejected from the pump cavity by the second driving member.
